(19) United States
(12) Patent Application Publication
(10) Pub. No.: US 2012/0196957 A1
(43) Pub. Date: Aug. 2, 2012

(54) Compatibilizer Blend For Polymeric Compositions

(76) Inventors: Jeffrey Jacob Cernohous, Hudson, WI (US); Neil R. Granlund, Columbia Heights, MN (US)

(21) Appl. No.: 13/499,132

(22) PCT Filed: Sep. 28, 2010
(86) PCT No.: PCT/US10/50558

§ 371 Date: Mar. 29, 2012

Related U.S. Application Data
(60) Provisional application No. 61/246,703, filed on Sep. 29, 2009.

(51) Int. Cl. C08L 23/26; C08K 11/00; C08K 3/34; C08K 3/26; C08K 3/36; C08K 3/22; C08K 7/14

(52) U.S. Cl. 524/13; 524/531; 524/528; 524/433; 524/430; 524/427; 524/445; 524/436; 524/437; 524/514

(57) ABSTRACT

A compatibilizer blend having at least one compatibilizer and at least one desiccant to address the presence of certain interfering components, such as water, in a polymeric matrix.

### CROSS REFERENCE TO RELATED APPLICATIONS

This application claims priority to U.S. Provisional Patent Application No. 61/246,703 filed Sep. 29, 2009, the disclosure of which are herein incorporated by reference in its entirety.

### TECHNICAL FIELD

The present invention relates to a compatibilizer blend. Specifically, the present invention is a combination of a compatibilizer and a desiccant material for applications in polymer compositions, such as melt processable polymers.

### BACKGROUND

A compatibilizer is often added to blends of immiscible polymers to reduce the interfacial tension between them. Compatibilizers have also been employed to improve wet out or coupling of polymers and additives or fillers in composite materials. In both cases, the addition of compatibilizer can result in improved processing and mechanical properties of the resulting blend or composite. Functionalized copolymers are a class of materials applied as compatibilizers. In general, functionalized copolymers are polymers that have some form of reactive functional groups incorporated throughout the polymer backbone. Polyolefins functionalized with maleic anhydride are one class of materials that have been applied as compatibilizers.

Certain compatibilizers utilized in melt processing applications may not function as intended due to factors and elements that interfere with their performance. For example, the functionality of some compatibilizers is adversely affected by the other adjuvants or components present in the melt process. Certain materials may interfere with the functionality of the compatibilizer and prevent the modification of interfacial tension between the immiscible or incompatible materials. Often, as a result of the interference, the melt composition prior to melt processing is overloaded with compatibilizer well beyond theoretical requirements in order to assure that at least some of its intended function is carried out. This may negatively impact both the physical characteristics of the melt processed material and the economics of the melt processed compound.

### SUMMARY

The present invention is directed at a solution to address the presence of interfering elements when combining incompatible materials in a polymer matrix. The blend of at least one compatibilizer and at least one desiccant addresses the presence of certain interfering components, such as water, in a polymeric matrix and permits the compatibilizer to function at levels closer to theoretical. The inventive composition is particularly suited for applications involving moisture laden fillers, but is also suitable for many other material combinations where water content can adversely affect the performance of the compatibilizer or the resulting melt processed composition. The compatibilizer blend is capable of producing new polymeric composites with an attractive balance of physical properties.

For the purpose of this invention, compatibilizers are those materials generally possessing reactive functionality that is capable of interaction with immiscible or incompatible materials. In many instances, the compatibilizers or the compatibilization chemistry is susceptible to moisture and will readily react with water present in either the melt processable matrix or other components included in the melt processable matrix. To alleviate this issue, the compatibilizers of this invention include a desiccant. The desiccants include materials that are capable of absorbing or reacting with water, thereby tying up the water and enabling the compatibilizer to function as intended.

The compatibilizer blend of the present invention is well suited in applications utilizing functionalized copolymers as compatibilizers. The compatiblizing chemistry or the functionalized copolymer itself may be often moisture sensitive. This is problematic as the compatibilizer is often utilized to improve the mixing and dispersion of hydrophilic and hydrophobic polymers and/or fillers. Water can interfere with the compatibilizing chemistry thus reducing the compatibilizer efficiency. Compatibilizer blends utilizing a desiccant address the interfering water component, particularly in melt processable polymer matrices.

The compatibilizer blend may be applied to a polymeric matrix containing different polymers, polymer blends or composites materials. One embodiment particularly suited for the compatibilizer blend is hygroscopic materials that are sensitive to moisture. Non-limiting examples include polyamides, polyesters, polycarbonates, polyacrylates, or polyethacrylates.

The polymeric matrix may contain one or more fillers. Fillers are often added to polymers to impart desirable physical characteristics or to reduce the amount of polymer needed for a given application. Fillers often contain moisture and therefore reduce efficacy of a compatibilizer present in a polymeric matrix. Non-limiting examples of fillers include wood fiber, natural fiber, glass fiber, calcium carbonate, talc, silica, clay, magnesium hydroxide, and aluminum trihydroxide.

The compatibilizer blend is capable of producing new polymeric composites with an attractive balance of physical properties. The compatibilizers of this invention have been found to improve the flexural, tensile and impact properties of composite materials. Incorporation of as little as one weight percent of the compatibilizers of this invention into a composite formulation has been found to improve the mechanical properties mentioned by as much as two-fold. The compatibilizer blends of this invention are also much more efficient when compared to conventional compatibilizers generally known to those of ordinary skill in the art. In some cases, the compatibilizer blends of this invention are as much as twice as efficient (i.e., half the amount is required to achieve comparable mechanical property improvement) than compatibilizers known in the art.

For purposes of the present invention, the following terms used in this application are defined as follows:

“Polymeric Matrix” means a melt processable polymeric materials or resins.

“Compatibilizer” means a compound that is capable of modifying the interfacial tensions between immiscible or incompatible materials, including polymers.

“Desiccant” means a material that is capable of physically or chemically reacting, absorbing, or combining with water.

“Filler” means an organic or inorganic material that does not possess viscoelastic characteristics under the conditions utilized to melt process the filled polymeric matrix.

“Composite” means a mixture of a polymeric material and a filler.

“Melt Processable Composition” means a formulation that is melt processed, typically at elevated temperatures, by means of a conventional polymer processing technique such as extrusion or injection molding as an example.

“Hygroscopic Materials” include polymers or fillers that contain more than 0.1% moisture at controlled temperature (21° C.) and humidity (50% relative humidity).

“Melt Processing Techniques” means extrusion, injection molding, blow molding and rotomolding batch mixing.

The above summary of the present invention is not intended to describe each disclosed embodiment or every implementation of the preset invention. The detailed description that follows more particularly exemplifies illustrative embodiments.

### DETAILED DESCRIPTION

A compatibilizer blend comprising at least one compatibilizer and at least one desiccant addresses the presence of certain interfering components, such as water, in a polymeric matrix. The application of the desiccant in the blend permits the compatibilizer to function at levels closer to theoretical. The composition is particularly suited for applications where water content can adversely affect the performance of the compatibilizer or the resulting melt processed composition.

Compatibilizer components in the compatibilizer blend include those that are capable of modifying the interfacial tensions between immiscible or incompatible materials. The compatibilizers possess a functional group that interacts with either the immiscible polymers or the incompatible fillers. The functional groups can be either nucleophilic or electrophilic in nature. Non-limiting examples of nucleophilic functional groups commonly incorporated into polymer backbones include amines, alcohols, acids, silanes and thiols. Non-limiting examples of electrophilic functional groups include epoxides, anhydrides, esters, acid chlorides and alkoxysilanes.

Preferred compatibilizer blends of this invention are polyolefin-graft-maleic anhydride copolymers that include a desiccant. In one embodiment, the desiccant is melt processed with a premade polyolefin-graft-maleic anhydride copolymer. In another embodiment, the polyolefin is reactively extruded with maleic anhydride in the presence of a desiccant.

The free radical initiator may be used in conjunction with a functional ethylenically unsaturated monomer to create a compatibilizer. Non-limiting examples of ethylencially unsaturated monomers include a-olefins (e.g., 1-butene, 1-hexene, 1-octene), α,o-functionalized olefins (e.g., amine, hydroxyl, carboxylic acid, anhydride terminal), α,β-unsaturated aldehydes, α,β-unsaturated ketones, α,β-unsaturated esters (e.g., acrylates, methacrylates, maleates) and vinyl silanes. In one embodiment, maleic anhydride is utilized as the functional ethylenically unsaturated monomer.

A free radical catalyst, such as a peroxide, is suited for initiating the compatibilizer. Non-limiting examples of suitable peroxide initiators include t-butyl perbenzoate, dicumyl peroxide, methylethylketone peroxide, benzoyl peroxide, di-tbutyl peroxide, and 2,5 dimethyl-2,5-di(t-butyl peroxy)hexane.

In one embodiment, a compatibilizer blend is derived from recycled diapers, recycled polymeric material, or combinations thereof. These recycled materials are reactively extruded with a free radical initiator, a functional ethylenically unsaturated monomer and a desiccant to form the compatibilizer. In one embodiment, the 0.1 to 20-wt % of a functional ethylenically unsaturated monomer is incorporated into the recycled material. In yet another embodiment, 0.1 to 5-wt % is incorporated into recycled material. In certain embodiments with recycled materials, the desiccant may be an optional additive.

In one embodiment, amounts of about 10-50%, in another embodiment 5-10%, and in yet another preferably 0.2-5% of the compatibilizer blend is incorporated into composite formulations and melt processable compositions.

The function of the desiccant in the compatibilizer blend is to address the moisture in the filler, the polymer matrix, or both in order to allow the compatibilizer to serve its intended function. The desiccant may be any conventional material capable of moisture uptake and suitable for application in melt processed polymeric matrices. In one embodiment, the desiccant is selected from calcium oxide, magnesium oxide, strontium oxide, barium oxide, aluminum oxide, or combinations thereof. Those of ordinary skill in the art of melt processing polymers are capable of selecting a specific desiccant in combination with a compatibilizer to achieve the beneficial results disclosed with the present invention. The amount of desiccant will vary, but may include a range of about 1 to 80 wt % of the formulation in the compatibilizer blend.

The polymeric matrix functions as the host polymer and is a component of the melt processable composition upon which the desiccant and compatibilizer are added. A wide variety of polymers conventionally recognized in the art as suitable for melt processing are useful as the polymeric matrix. The polymeric matrix substantially includes polymers that are sometimes referred to as being difficult to melt process, especially when combined with an interfering element or another immiscible polymer. They include both hydrocarbon and non-hydrocarbon polymers. Examples of useful polymeric matrices include, but are not limited to, polyamides, polyimides, polyurethanes, polyolefins, polystyrenes, polyesters, polycarbonates, polyketones, polyureas, polyvinyl resins, polyacrylates and polymethylacrylates.

In one embodiment, polymeric matrices include high density polyethylene (HDPE), low density polyethylene (LDPE), linear low density polyethylene (LLDPE), polypropylene (PP)), polyolefin copolymers (e.g., ethylene-butene, ethylene-octene, ethylene vinyl alcohol), polystyrene, polystyrene copolymers (e.g., high impact polystyrene, acrylonitrile butadiene styrene copolymer), polyacrylates, polymethacrylates, polyesters, polyvinylchloride (PVC), fluoropolymers, liquid crystal polymers, polyamides, polyether imides, polyphenylene sulfides, polysulfones, polyacetals, polycarbonates, polyphenylene oxides, polyurethanes, thermoplastic elastomers, epoxies, alkyds, melamines, phenolics, ureas, vinyl esters or combinations thereof. In certain embodiments, the most suitable polymeric matrices are polyolefins.

Polymeric matrices that are derived from recycled plastics are also applicable as they are often lower cost. However, because such materials are often derived from materials coming from multiple waste streams, they may have vastly different melt rheologies. This can make the material very problematic to process. The processing of such materials with interfering elements, such as moisture, can be even more problematic. The compatibilizer blend described herein provides a solution to this problem. This should have a significant commercial impact as it will allow very low cost, and filled recycled plastics to be converted into useful products instead of being landfilled.

The polymeric matrix is included in the melt processable compositions in amounts of typically greater than about 30% by weight. Those skilled in the art recognize that the amount of polymeric matrix will vary depending upon, for example, the type of polymer, the type of compatibilizer, the selected desiccant, the type of interfering element, the processing equipment, processing conditions and the desired end product.

Melt processable polymeric composition is often combined with certain fillers and/or additives to both enhance the economics and to impart desired physical characteristics to the processed material. The fillers may be hygroscopic and can include various organic or inorganic materials mixed throughout the polymeric host material. For example, wood flour or wood fibers are often included with certain hydrocarbon polymers to make composites that are suitable as structural building material upon melt processing. In one embodiment, the filler is selected from wood fiber, natural fiber, glass fiber, calcium carbonate, talc, silica, clay, magnesium hydroxide, or aluminum trihydroxide. In certain embodiments, the amount of filler in the polymeric matrix can range from 1 to 80 wt % of the formulation. In one embodiment, the filler is hygroscopic.

The melt processable composition may alternatively contain a hygroscopic polymer. In one embodiment, the hygroscopic polymer is any polymer that contains at least 0.1 wt % moisture. Non-limiting examples of hygroscopic polymers include, polyamides, polyimides, polycarbonates, polyesters, polyethers or combinations thereof. In another embodiment, a filler is additionally included in the composite formulation.

In another aspect of the invention, the melt processable composition may contain other additives. Non-limiting examples of conventional additives include antioxidants, light stabilizers, fibers, blowing agents, foaming additives, antiblocking agents, heat stabilizers, impact modifiers, biocides, flame retardants, plasticizers, tackifiers, colorants, processing aids, lubricants, coupling agents, and pigments. The additives may be incorporated into the melt processable composition in the form of powders, pellets, granules, or in any other extrudable form. The amount and type of conventional additives in the melt processable composition may vary depending upon the polymeric matrix and the desired physical properties of the finished composition. Those skilled in the art of melt processing are capable of selecting appropriate amounts and types of additives to match with a specific polymeric matrix in order to achieve desired physical properties of the finished material.

The melt processable composition of the invention can be prepared by any of a variety of ways. For example, the polymeric matrix, compatibilizer blend and the filler can be combined together by any of the blending means usually employed in the plastics industry, such as with a compounding mill, a Banbury mixer, or mixing. The materials may be used in the form, for example, of a powder, a pellet, or a granular product. The mixing operation is most conveniently carried out at a temperature above the melting point or softening point of the polymeric matrix. The resulting melt-blended mixture can be either extruded directly into the form of the final product shape or pelletized or otherwise comminuted into a desired particulate size or size distribution and fed to an extruder, which typically will be a single-screw extruder, that melt-processes the blended mixture to form the final product shape. In one embodiment, the compatibilizer blend is premade in a separate melt processing step using a twin screw extruder. The resulting composite exhibits superior performance results when the compatibilizer blend is premade using this protocol.

Melt processing typically is performed at a temperature from 120° to 300° C., although optimum operating temperatures are selected depending upon the melting point, melt viscosity, and thermal stability of the composition. Different types of melt processing equipment, such as extruders, may be used to process the melt processable compositions of this invention. Extruders suitable for use with the present invention are described, for example, by Rauwendaal, C., “Polymer Extrusion,” Hansen Publishers, p. 11-33, 2001.

The composites of this invention are suitable for manufacturing articles in many industries including the construction and automotive industries. For example, in the construction industry articles incorporating the composition of the present invention may include: decking, sheeting, structural elements, roofing tiles, and siding. The improved mechanical properties of the present invention enable thin and or hollow profiles, thereby reducing cost and weight for particular end use applications. Applications in the automotive industry include: body and interior panels and decorative articles. In some embodiments, the end use article may be sufficiently strong enough to permit the application of the molded article without metal or alloy strengthening supports.

The resulting articles produced by melt processing the inventive composition exhibit superior mechanical characteristics. For example, composites of this invention have flexural and impact properties as much as 40% greater than composites containing maleated compatilizers known in the art at comparable loading levels.

### Example 1

| Material | Supplier |
|---|---|
| CA1 | Exxelor 1020A, Maleic anhydride grafted |
| | polypropylene, commercially available from |
| | Exxon Mobil Corporation, Baytown, TX. |
| CA2 | Polybond 3029, Maleic anhydride grafted |
| | polyethylene, commercially available from |
| | Chemtura Inc., Middlebury, CT. |
| HDPE1 | 6706.17, High Density Polyethylene, |
| | commercially available from Exxon Mobil |
| | Corporation, Baytown, TX |
| HDPE2 | 6719.17, High Density Polyethylene, |
| | commercially available from Exxon Mobil |
| | Corporation, Baytown, TX |
| PP | 5262, Polypropylene homopolymer, commercially |
| | available from Exxon Mobil Corporation, |
| | Baytown, TX |
| R-PP | Diaper Scrap, commercially available from Maine |
| | Plastics, Inc, Zion, IL. |
| Desiccant | Polycal OFT15, Calcium Oxide, commercially |
| | available from Mississippi Lime, St. Louis, MO |
| Maleic Anhydride | Commercially available from Aldrich Chemical |
| | Co., Milwaukee, WI. |
| DHBP | 2,5-Dimethyl-2,5-di(tertbutyl peroxy) hexane, |
| | commercially available from United Initiators, |
| | Elyria, OH |
| Wood Flour | 40 mesh maple, commercially available from |
| | American Wood Fibers, Schofield, WI. |

Compounding Procedure for Compatibilizers A and B

For production of compatibilizers A and B the following procedure was utilized. Resin (PP or HDPE) and desiccant were mixed in plastic bag and volumetrically fed into a 26 mm co-rotating twin screw extruder (40:1, L:D) fitted with a four strand die (commercially available from Labtech Engineering, Muang, Thailand). All samples were processed at 300 rpm screw speed using the following temperature profile: Zone 1-2=210° C., Zone 3-4=190° C., Zone 5-7=180° C., Zone 8-9=170, Die=180° C. The resulting strands were subsequently air cooled and pelletized into 0.64 cm pellets.

Compounding Procedure for Compatibilizers C, D and E

For production of compatibilizers C, D and E the following procedure was utilized. Resin (PP or HDPE), maleic anhydride, DHBP and optionally desiccant were mixed in plastic bag and volumetrically fed into a 26 mm co-rotating twin screw extruder (40:1, L:D) fitted with a four strand die (commercially available from Labtech Engineering, Muang, Thailand). All samples were processed at 300 rpm screw speed using the following temperature profile: Zone 1=165° C., Zone 2=185° C., Zone 3-4=165° C., Zone 5-7=205° C., Zone 8-9=210° C., Die=180° C. The resulting strands were subsequently air cooled and pelletized into 0.64 cm pellets.

Compounding Procedure for CE1-8 and Examples 1-7

For Comparative Examples CE1-4 and examples 1-5, wood flour was pre-dried in a desiccant dryer for 4 hours at 200° F., such that the overall moisture content was less than 0.5% by weight. For Comparative Examples CE5-CE8 and Examples 6-7, wood flour was not pre-dried and had an approximate moisture content of 8% by weight. PP and additives were dry mixed in a plastic bag. The additive/PP blend and wood flour were fed using two volumetric feeders into a 26 mm co-rotating twin screw extruder (40:1, L:D) fitted with a four strand die (commercially available from Labtech Engineering, Muang, Thailand). All samples were processed at 300 rpm screw speed using the following temperature profile: Zone 1-2=210° C., Zone 3-4=190° C., Zone 5-7=180° C., Zone 8-9=170° C., Die=180° C. The resulting strands were subsequently air cooled and pelletized into 0.64 cm pellets. The resulting pellets were injection molded into test specimens following ASTM D638 (tensile) and D790 (flexural) specifications. Injection molding of the composite formulations was performed using an 85 ton machine (commercially available from Engel
Corporation, York, Pa.) having a barrel and nozzle temperature of 180° C. The flexural and impact properties were subsequently tested as specified in ASTM D790 and D256, respectively.

Table 1 gives the formulations for compatibilizers A, B, C, D and E. Table 2 gives the formulations for comparative examples CE1-CE8 and examples 1-7. Table 3 provides the mechanical properties of comparative examples CE1-CE8 and examples 1-7.

TABLE 1
Compatibilizer formulations A-E

| | | | | | | | Maleic | |
|---|---|---|---|---|---|---|---|---|
| Compatibilizer | CA2 | CA1 | CaO | HDPE2 | PP2 | R-PP2 | Anhydride | DHBP |
| A | 50 | — | 50 | — | — | — | — | — |
| B | — | 50 | 50 | — | — | — | — | — |
| C | — | — | 50 | 48.9 | — | — | 1 | 0.10 |
| D | — | — | 50 | — | 48.75 | | 1 | 0.25 |
| E | — | — | — | — | — | 98.75 | 1 | 0.25 |

TABLE 2
Composite Formulations CE1-CE8 and Examples 1-7

| | | | dry wood | Wet wood | | | | | | | |
|---|---|---|---|---|---|---|---|---|---|---|---|
| Example | HDPE1 | PP1 | flour | flour | CA2 | CA1 | A | B | C | D | E |
| CE1 | 50 | — | 50 | — | — | — | — | — | — | — | — |
| CE2 | — | 50 | 50 | — | — | — | — | — | — | — | — |
| CE3 | 48 | — | 50 | — | 2 | — | — | — | — | — | — |
| CE4 | — | 48 | 50 | — | — | 2 | — | — | — | — | — |
| CE5 | 46 | — | — | 54 | — | — | — | — | — | — | — |
| CE6 | — | 46 | — | 54 | — | — | — | — | — | — | — |
| CE7 | 44 | — | — | 54 | 2 | — | — | — | — | — | — |
| CE8 | — | 44 | — | 54 | — | 2 | — | — | — | — | — |
| 1 | 48 | — | 50 | — | — | — | 2 | — | — | — | — |
| 2 | — | 48 | 50 | — | — | — | — | 2 | | — | — |
| 3 | 48 | — | 50 | — | — | — | — | — | 2 | — | — |
| 4 | — | 48 | 50 | — | — | — | — | — | — | 2 | — |
| 5 | — | 48 | 50 | — | — | — | — | — | — | — | — |
| 6 | 44 | — | — | 54 | — | — | 2 | — | — | — | — |
| 7 | — | 40 | — | 54 | — | — | — | 2 | — | — | — |

TABLE 3
Mechanical Properties of Composite Formulations
CE1-CE8 and Examples 1-7

| | Flexural modulus | Flexural Strength | |
|---|---|---|---|
| Example | (Mpa) | (Mpa) | Impact (J/cm) |
| CE1 | 2920 | 35 | 0.6 |
| CE2 | 3720 | 49 | 0.6 |
| CE3 | 3400 | 59 | 1.7 |
| CE4 | 4280 | 86 | 1.8 |
| CE5 | 2850 | 37 | 1.1 |
| CE6 | 3370 | 53 | 1.1 |
| CE7 | 3030 | 58 | 1.6 |
| CE8 | 3900 | 87 | 1.5 |
| 1 | 4420 | 71 | 2.5 |
| 2 | 3440 | 66 | 2.0 |
| 3 | 3550 | 59 | 1.5 |
| 4 | 4280 | 77 | 1.5 |
| 5 | 4310 | 56 | 1.4 |
| 6 | 3480 | 58 | 1.4 |
| 7 | 4290 | 79 | 1.8 |

From the above disclosure of the general principles of the present invention and the preceding detailed description, those skilled in this art will readily comprehend the various modifications to which the present invention is susceptible. Therefore, the scope of the invention should be limited only by the following claims and equivalents thereof.

What is claimed is:

1. A composition comprising a compatibilizer and a desiccant.

2. A composition according to claim 1, wherein the compatibilizer is a functionalized polymer.

3. A composition according to claim 1, wherein the compatibilizer is derived from a recycled material.

4. A composition according to claim 3, wherein the compatibilizer is selected from recycled diapers, recycled polymeric material, or combinations thereof.

5. A composition according to claim 1, wherein the desiccant is selected from calcium oxide, magnesium oxide, strontium oxide, barium oxide, aluminum oxide, or combinations thereof.

6. A composition according to claim 1, further comprising a polymeric matrix.

7. A composition according to claim 6, further comprising a filler.

8. A composition according to claim 7, wherein the filler is selected from wood fiber, natural fiber, glass fiber, calcium carbonate, talc, silica, clay, magnesium hydroxide, aluminum trihydroxide.

9. A composition according to claim 6, further comprising a hygroscopic material selected from polyamides, polyimides, polycarbonates, polyesters, polyethers or combinations thereof.

10. A method comprising melt processing a polymeric matrix, a desiccant, an initiator, and an ethylenically unsaturated monomer.

11. A method comprising melt processing the composition of claim 1 and a hygroscopic material.

12. A method according to claim 11, wherein the hygroscopic material is a polymer, a filler, or combinations thereof.

13. A composition comprising a compatibilizer derived from recycled material and optionally a desiccant.

14. The composition according to claim 13, further comprising a polymeric matrix.

15. A method comprising a reactively extruding a polymeric matrix with maleic anhydride and a desiccant.
